(19) United States
(12) Patent Application Publication
(10) Pub. No.: US 2025/0018608 A1
(43) Pub. Date: Jan. 16, 2025

(54) MIXING HEAD AND METHOD FOR PRODUCING A MIXING HEAD

(71) Applicant: KRAUSSMAFFEI TECHNOLOGIES GMBH, Parsdorf (DE)

(72) Inventors: Jürgen MATZEL, Alling (DE); Ralf MOSER, München (DE); Christian SCHMID, Egling (DE)

(21) Appl. No.: 18/706,552

(22) PCT Filed: Oct. 24, 2022
(86) PCT No.: PCT/EP2022/079507

§ 371 Date: May 1, 2024

(30) Foreign Application Priority Data
Nov. 11, 2021 (DE) 10 2021 129 386.3

(51) Int. Cl. B29B 7/76

(52) U.S. Cl. CPC B29B 7/7694; B29B 7/7615; B29B 7/7636; B29B 7/7652; B29B 7/7668

(57) ABSTRACT

The application relates to a mixing head including a head part and a mixing chamber device which is arranged in the head part. The mixing chamber device has a mixing chamber, which includes at least two inlets for introducing a starting material into the mixing chamber, and an outlet, via which the starting material mixture can be discharged out of the mixing chamber. A control piston is movably arranged in the mixing chamber. The mixing chamber device is releasably arranged in the head part in order to be exchangeable, wherein a transition fit and/or a clearance fit is formed between the head part and the mixing chamber device. The application additionally relates to a production method.

### TECHNICAL FIELD

The present invention relates to a mixing head comprising a head part and a mixing chamber device which is arranged in the head part, and a method for mounting a mixing head.

### PRIOR ART

Generally, mixing heads are known for use for the processing of reactive components or respectively polymeric components for production the of mostly thermoset materials, in particular of polyurethane. In the case of such mixing heads, at least two reactive starting materials are intimately mixed with one another in a mixing chamber and the mixture is then discharged from the mixing chamber.

Generic mixing heads are already known from the prior art. For example, DE 195 15 039 A1 discloses a device for the mixing of at least two chemically reactive plastic components under high pressure, with a cylindrical mixing chamber into which the components are injected, wherein a reversible piston is arranged for the discharging of remaining plastic mixture within the mixing chamber. The device also has a cylindrical settling chamber/outlet chamber/outlet channel which adjoins the mixing chamber and runs at an angle of preferably 90° to the longitudinal axis of the mixing chamber, wherein in the settling chamber a reversible cleaning piston is arranged for discharging the reactive plastic mixture out from the settling chamber. On its cylindrical covering surface the cleaning piston has depressions configured, which are filled with spacer material and are arranged in a spiral-shaped manner on the covering surface, so that on an axial movement of the cleaning piston, the latter is set in rotation. On an axial movement of the piston, this leads to an interruption of the surface shell and thus serves as a protection against wear.

In the mixing chamber, a control piston is arranged in a known manner, which is received movably to and fro. Recirculation grooves are worked in the control piston here, which serve to guarantee a recirculation, therefore a back-flow, of the starting materials to the outlet container, in a forward-driven switch position closing the mixing chamber per se (recirculation phase). Such a recirculation via these recirculation grooves is also known and does require any further explanation. In a withdrawn switch position of the control piston, the mixing chamber is freed, the starting materials can mix with one another and are subsequently discharged out from the mixing chamber (discharge phase). Such a mixing head is known for example from EP1979143A1.

In the case of the known mixing heads, the mixing chamber is worked directly into the head part or alternatively is shrink-fitted by means of a bush. Thereby, a simple exchange of the mixing chamber is not possible in recirculation mixing heads. If the mixing chamber no longer operates properly through wear, the mixing head must be either completely exchanged or must be at least dismantled and reworked mechanically in a laborious manner with subsequent heat treatment, or a new bush with mixing chamber must be inserted by means of shrink technology, with subsequent precise machining and restoration of the nozzle installation spaces.

### DESCRIPTION OF THE INVENTION

It is an object of the present invention to create a mixing head, the maintenance and repair of which is simplified compared to the known solutions, and thus to achieve, in so doing, a saving with respect to time and cost.

The problem is solved by the subjects of the independent claims. Advantageous further developments of the invention are indicated in the dependent claims, in the description and in the accompanying figures. In particular, the independent claims of one claim category can also be further developed in an analogous manner to the dependent claims of another claim category.

A mixing head according to the invention has a head part and a mixing chamber device arranged in the head part. The mixing chamber device has at least one mixing chamber and at least two inlets for the entry of starting material into the mixing chamber. The mixing head is provided for the production of reaction plastics. Furthermore, an outlet is provided, via which the mixture of the starting materials is able to be discharged out from the mixing chamber, wherein a control piston is movably arranged in the mixing chamber. The mixing chamber device is arranged detachably here in the head part, in order to be exchangeable. A transition fit and, additionally or alternatively, a clearance fit, is formed here between the head part and the mixing chamber device.

Furthermore, the mixing head has at least two recirculation outlets. A recirculation outlet is associated here respectively with each inlet for introducing starting material. The mixing head and in particular the control piston of the mixing head are formed such that in closed position a fluid connection exists between the inlet and the associated recirculation a outlet, so that recirculation is possible of the starting material, able to be introduced via the inlet, towards the associated recirculation outlet. The mixing head therefore has at least one recirculation outlet per inlet, which in closed position of the c piston are connected to the respectively associated inlet for recirculation.

The mixing head can concern a mixing head for a reaction moulding machine for producing reaction plastic. Thus, it can concern a polyurethane foaming system which is prepared for the production of reaction plastics such as polyurethane foams. Reaction plastics generally consist of two (reactive) components (stock and hardener) and any further additives, and harden through chemical reaction with one another. The, in particular reactive, components can be understood as starting material. A component of the surrounding atmosphere can also co-react. Here, the mixing can take place only directly before the application, whereupon the hardening then begins. The reaction plastic is designated as reaction resin in process-ready state before the chemical hardening. A reaction plastic can be understood to mean for example epoxy resin (EP), polyurethane (PU/PUR), nylon or respectively polyamide (thermoplastic—but is produced in the mixing head as polyaddition), DPCD dicyclopentadiene/polyester), or unsaturated polyester (UP).

In particular, the mixing head can be used for the production of polyurethane (PUR). The basic components from which the PUR material is made up are polyol and isocyanate, wherein in particular on the polyol side mixtures of various polyols can be used. The processing of such a multi-component reaction system can be designated as reaction casting. When the reaction mixture additionally contains a propellant and is thus foamable, it can also be designated as reaction foam moulding. The mixing head is based on the counterflow injection principle and uses the mixing effect of turbulent flow. The delivered components can have a pressure of over 50 bar, in particular between 100 bar and 250 bar.

In particular, the concern can be with a clearance fit. A clearance fit generally means that the minimum dimension of the bore is always greater than (in borderline cases equal in size to) the maximum measurement of the shaft. As a nominal size of fits can neither be maintained nor is it expedient to be maintained for example for economic reasons, bores and shafts always have tolerance fields. The shaft is representative here in the illustration for the mixing chamber device, or respectively its outer contour. Accordingly, the bore is representative here for the mount of the mixing chamber device in the head part. The mixing chamber device can thus also be designated as mixing chamber bush. Tolerance classes enable here various requirements to be maintained with regard to the fit. These requirements can basically be differentiated in three variations, in which the tolerance field of the bore and that of the shaft relate to one another. In detail, these are: clearance fit, transition fit and interference fit. In DIN 7157 all three variants are specified for the standard bore, whereas the standard shaft is standardized only with clearance fit. A shaft can always have a clearance with respect to a bore, therefore a desired distance can exist between the outer boundary of the shaft and the inner of the bore. A prerequisite for this clearance fit is, of course, that the maximum dimension of the shaft is always smaller than the minimum dimension of the bore. As it is not assumed in the case of a clearance fit that the maximum dimension of the shaft is not reached simultaneously with the minimum dimension of the bore, in rare cases both dimensions can also be identical. In addition, in the case of a clearance fit, care is to be taken that the tolerance fields are selected so that the maximum clearance, therefore the maximum distance between minimum dimension of the shaft and maximum dimension of the bore, fulfils a feasible value.

The starting material can concern reactive components or respectively polymeric components. This can be for example a polyol (or a polyol mixture) and an isocyanate.

The mixing head can concern either a linear mixing head or a deflector mixing head.

The at least two inlets and the outlet of the mixing chamber can be formed here in the mixing chamber device already before the joining with the head part. Thus, advantageously, after the joining together of the mixing chamber device with the head part, a laborious subsequent work can be dispensed with, and the mixing head is, as it were, immediately ready for use after the joining. The advantage of the solution is that the mixing chamber device can be changed easily and can thus be exchanged in a short space of time in the case of wear. Thereby, the downtime of the mixing head can be reduced or respectively can be kept short. The recirculation outlets can also be already formed accordingly and positioned accordingly, such that also no subsequent work is necessary here.

The inlets and/or recirculation outlets can be sealed between the head part and the mixing chamber. For this, a or seal a sealing arrangement can be provided, or alternatively or additionally this can be achieved by an adhesive or a surface seal. The seal can also be formed as an O-ring. Alternatively, the seal could also be formed for example as an elastomer sleeve, cut elastomer sleeve (so-called sealing sock), a variant of an elastomer- or plastic seal (Glyd ring, Stepseal, etc.) or as a seal which is prestressed with elastic elements (shaft seal, stripper, etc.).

An outlet chamber can be arranged onto the mixing chamber at the outlet side. The outlet chamber can be formed in one piece. The outlet chamber can be exchangeable. The outlet chamber can also be designated as outlet channel. Here, a cleaning piston can be able to be inserted into the outlet chamber. Thus, the concern can also be with a deflector mixing head.

The control piston can have at least two control grooves. The control grooves can be formed symmetrically with respect to one another here (in particular in the case of an even number of control grooves), or alternatively the control piston can have at least three control grooves which are arranged evenly distributed with respect to one another on the covering surface of the control piston, in order to reduce wear. Such a regular arrangement of the control grooves can reduce the inevitable wear. The control piston can thus move more easily centrally in the mixing chamber. The control grooves can also be designated as recirculation grooves. A starting material, delivered via an inlet, i.e. for example a reactive component or a polymeric component, can be guided via the control groove or recirculation groove in the control piston for the recirculation outlet and kept from there in a circuit as long as the control piston is arranged in the closed state of the mixing head. When the control piston moves away from the outlet, the inlet or respectively the inlets are closed for a short moment, in order to then free a connection from the inlet via the mixing chamber to the outlet.

The control piston can be formed having multiple parts. Alternatively, the control piston can be formed in one piece. Thus, it can be produced simply and mounted simply. A damage to the control piston can thus also be prevented more easily.

The mixing chamber can have at least one radial groove in order to produce an axial seal. Through an anterior radial groove in the mixing chamber, a pure cylindrical clearance between control piston and mixing chamber is possible. A close clearance is not necessary here at the front, i.e. a dedicated fit is not necessary. An exchangeability can thus be achieved. Functionally therefore a self-forming seal can be produced. For example, self-forming seals can lead to a stripping off of the reactive material through two radial grooves in the mixing chamber. The action can become even more effective through a second radial groove or further radial grooves. Alternatively, a rod seal, for example vector seal, wiper ring or Glyd ring can be provided. A Glyd ring can be understood to mean a sealing element known in hydraulics, which creates an external seal for pistons.

The mixing chamber device can be constructed in a mirror-symmetrical manner. This can thus be manufactured particularly easily (substantially as a turned part with bores). The mirror-symmetry refers here to the base body. Through the mirror-symmetry, wear can also be reduced.

The mixing head can provide an outlet chamber device, also designated as outlet tube, which is arranged transversely to the direction of movement of the control piston, wherein the outlet tube has a recess for the mixing chamber device. The recess can be embodied as a bore. The recess can have a depth here which is smaller than the radius of the external diameter of the outlet tube. An undercut configuration (of the mixing chamber device) can thus be dispensed with.

The mixing chamber device can have at least one recess, formed as a groove, on the cylindrical outer wall, for a ledge. At least one groove or recess can be formed in a cylindrical inner wall of the head part. In the at least one recess a ledge can be arranged here, which engages into the groove of the cylindrical inner wall in order to ensure an alignment of the mixing chamber device to the head part, and additionally or alternatively to prevent a rotation of the mixing chamber device. The recess, groove and ledge can be designated together as anti-rotation protection.

The mixing chamber device can have on the cylindrical outer wall at least one recess formed as a groove or bore for a pin. In a cylindrical inner wall of the head part, at least one bore or recess can be formed. Here, in the at least one recess a pin can be arranged which engages into the groove or bore of the cylindrical inner wall, in order to ensure an alignment of the mixing chamber device to the head part and additionally or alternatively to prevent a rotation of the mixing chamber device. Recess, bore/groove and pin can be designated together as anti-rotation protection.

The inventive idea can also be implemented in a method for mounting a mixing head. Here, the mixing head has a head part and a mixing chamber device arranged in the head part, which mixing chamber device has at least two inlets for introducing starting material, and an outlet via which the mixture of the starting materials is able to be discharged out from the mixing chamber. A control piston is movably arranged e mixing chamber. Here, a joining or dismantling of the mixing chamber device in and/or out from the head part takes place without the supply of thermal energy. Thus, a simple repair method can be achieved, as both the dismantling and also the subsequent renewed joining can take place with less effort, compared to when the mixing chamber was joined thermally as in the prior art.

The supply of thermal energy refers here to the fact that the head part and mixing chamber device are respectively manufactured from a material which has the same or a similar thermal expansion coefficient and thus a thermal energy supply has no direct effect on the gap size between head part and mixing chamber device. The mixing head can be inserted entirely in solvent or boiled in solvent, in order to detach stuck plastics or to soften the stuck plastic by heating, in order to thus enable a separating of head part and mixing chamber device.

One is thus also more free in the selection of material, because its thermal behaviour also does not have to be considered with regard to the mounting and possible dismantling. Thus, the head part and the mixing chamber device can have an identical or similar thermal expansion coefficient. The lacking supply of thermal energy can be understood here to mean for example that during the joining of the mixing chamber device into the head part or the dismantling of the mixing chamber device from the head part, a temperature of the mixing chamber device differs less than 50° Celsius from a temperature of the head part, and/or the temperature of the mixing chamber device and/or the temperature of the head part differ no more than 20° Celsius from the ambient temperature. The temperature differences are then to be understood for example purely from the production operation, as the processed materials are partly processed at high temperatures (for example in a range up to 220° C.). Usual processing temperatures of the components often lie below 120° C., generally below 90° C., or also below 45° C. Before a dismantling, the mixing head will cool down. Due to construction, the temperature of individual components can differ here if they cool down differently.

On the joining of the mixing chamber device into the head part, the mixing chamber can be aligned to the head part. Thus, after the joining, ideally no subsequent work is then necessary at all.

After the joining of the mixing chamber device into the head part, the at least two inlets, the at least two recirculation outlets and the outlet of the mixing chamber device can be aligned in a precisely fitting manner, in particular these can be aligned in a precisely fitting manner without subsequent work.

For mounting, firstly an outlet tube can be introduced into the head part, wherein the outlet tube is arranged transversely to the direction of movement of the control piston. The outlet tube can have a recess (in particular a bore) here for the mixing chamber device, wherein the recess has a depth which is smaller than the radius of the outlet tube. Furthermore, in a subsequent working step, the mixing chamber can be joined with the head part, wherein a plane surface of the recess of the outlet tube can define, as a stop, the position of the mixing chamber device in the direction of movement of the control piston.

For mounting, firstly an outlet tube can be introduced into the head part, wherein the outlet tube is arranged transversely to the direction of movement of the control piston. The outlet tube can have a recess (in particular a bore) here for the mixing chamber device, wherein the recess has a depth which is smaller than the radius of the outlet tube. Furthermore, in a subsequent working step, the mixing chamber can be joined with the head part, wherein a jump in diameter on the external diameter of the mixing chamber device on a stop of the head part defines the position of the mixing chamber device in the direction of movement of the control piston. The head part and mixing chamber device are adjacent at the stop in the region of the jump in diameter, in such an embodiment a small clearance remains between outlet tube and mixing chamber device—this clearance is then closed or respectively sealed with reactive material at the first shot.

The mixing chamber device can be braced in the head part by means of a sealing flange. This is easy to mount and is simple to produce.

In other words, a mixing chamber device, also designated as mixing chamber bush, is inserted into the head part in a precisely fitting manner through simple mounting without shrink technology. A subsequent processing of the mixing chamber/mixing chamber device or of the inlets, also designated as nozzle installation spaces, is no longer necessary here. Thereby, one is free in the choice of material of the bush. This is achieved as no shrink technology comes into play. In order to prevent a crossing over of the components, also designated as starting materials, at the external diameter of the mixing chamber device, corresponding sealing elements can be provided. Advantageously, therefore, the required time for repair of the mixing chamber is reduced to a minimum. An individual mixing chamber device or respectively a mixing chamber device together with a control piston are considerably more favourable than a complete mixing head. Corresponding replacement parts, i.e. mixing chamber devices and/or control pistons can thus be stored close to the machine in the event of maintenance.

The above explanations concerning the method apply accordingly for the device and vice versa.

### BRIEF DESCRIPTION OF THE FIGURES

An advantageous example embodiment of the invention is explained below with reference to the accompanying figures. There are shown:

FIG. 1-FIG. 5 respectively a sectional view through a mixing head according to example embodiments of the present invention;

FIG. 6 a mounting of the outlet chamber of a mixing head, in exploded view, according to an example embodiment of the present invention;

FIG. 7-FIG. 8 a mounting and alignment of the mixing chamber bush of a mixing head, in exploded view, according to an example embodiment of the present invention;

FIG. 9 a flowchart of a method for mounting a mixing head according to an example embodiment of the present invention.

The figures are only schematic illustrations and serve only to explain the invention. Identical elements or elements having the same effect are provided throughout with the same reference numbers.

### DETAILED DESCRIPTION

The example embodiment which is shown and described below shows a deflector mixing head. In this specific embodiment of a mixing head (for high pressure mixing), in which for example a direct connection of the mixing member to a tool is possible, the concern is with a self-cleaning embodiment of the mixing head. At the shot end, the remaining mixture is ejected by a piston (cleaning piston or cleaning plunger in the outlet chamber). After a sufficient reaction time has elapsed, which prevents a subsequent contamination of the mixing chamber, the piston travels back and frees the outlet chamber for the next shot. In the case of a linear mixing head, the outlet chamber is omitted and the starting materials are mixed in the mixing chamber, and the resultant reaction plastic (or respectively the reaction mixture forming the latter) is discharged directly out of the mixing chamber into the tool, and the remaining mixture is ejected by means of the control piston.

A linear mixing head is generally small and compact and thereby has a low weight. The simple production is also often advantageous, whereby these are also economical. Furthermore, the hydraulic or electric activation can be realized in a simple manner. Linear mixing heads can be sufficient for applications for closed foaming (here, the linear mixing head can be installed securely on the tool). Linear mixing heads are ideally suited for extremely fast-reacting plastic RIM, RRIM systems (often based on polyurea (PUA)).

A linear mixing head can be able to be executed relatively simply in a wear-protected manner by a wear-protected mixing chamber device which in accordance with the concept described here is additionally able to be exchanged easily. Machine immobilization times or downtimes can thus be kept small or avoided.

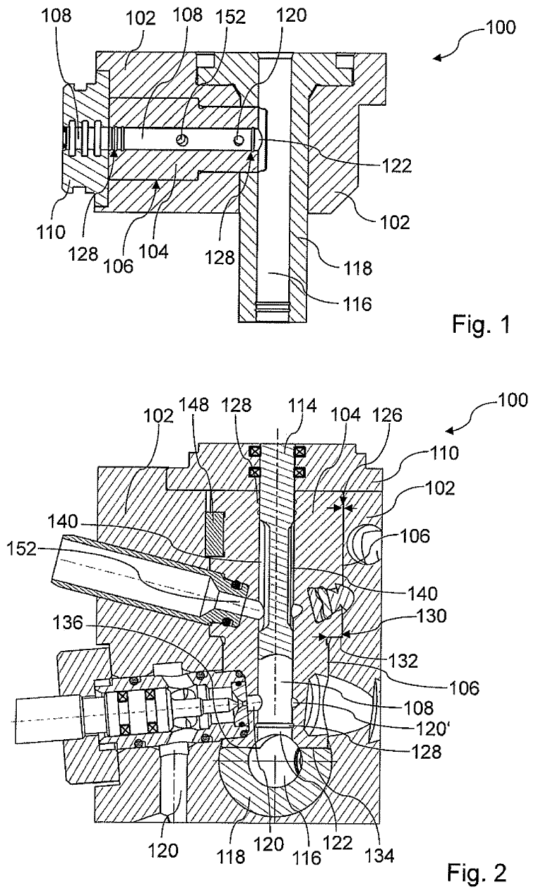

FIG. 1 shows a mixing head 100 with a head part 102 and a mixing chamber device 104 arranged in the head part 102. In the head part 102 a recess 106 is provided for the mixing chamber device 104. In the illustrated example embodiment, the base body of the mixing chamber device 104 is formed in a substantially rotationally symmetrical manner, comparable to a bush. As can also be seen from the figures, the insertions, bores, processed areas, nozzle installation spaces etc. of the mixing chamber device are formed in a mirror-symmetrical manner in the illustrated example embodiment. Here, the mixing chamber device 104 has a mixing chamber 108 which is formed centrally along the rotation axis of the mixing chamber device 104. Here in the present example embodiment, the mixing chamber 108 can be formed as a bore. The mixing chamber device 104 is held in the recess 106 of the head part 102 by means of a sealing flange 110. The sealing flange 110 has centrally a through-hole 112, through which a control piston 114—only shown in FIG. 2—which is axially movable in the mixing chamber 108, is able to be directed. In a finished mounted state, the control piston 114 extends through the through-hole 112 into the mixing chamber 108.

Transversely to the mixing chamber 108 or respectively to the mixing chamber device 104 in which the mixing chamber 108 is arranged an—in particular one-piece-outlet chamber 116 is formed. In the illustrated example embodiment the outlet chamber 116 is formed in an exchangeable outlet chamber device 118. In an example embodiment which is not illustrated, a cleaning piston runs in the outlet chamber 116. The outlet chamber device 118 in the illustrated example embodiment is formed in a rotationally symmetrical manner, but this is not absolutely necessary (mostly at least mirror-symmetrical, apart from the opening to the mixing chamber 108 or respectively to the mixing chamber device 104).

The mixing chamber 108 has an inlet 120. Furthermore, the mixing chamber 108 has a second inlet 120′ arranged symmetrically with respect to the first inlet 120—this is not illustrated, which runs, as it were, out of the plane of the drawing in the direction of the observer. Through the two inlets 120, starting material can be introduced into the mixing chamber 108, which material is mixed there (under pressure) and is then discharged through an outlet 122 out from the mixing chamber 108 into the outlet chamber 116. The inlets 120 extend from the wall of the mixing chamber 108 through the mixing chamber device 104 onto the outer side of the mixing chamber device 104.

In the head part 108 a mixing chamber recess 106 is formed. This can be formed for example as a bore when the mixing chamber device 104 is rotationally symmetrical at least in the outer contour and has a cylindrical covering surface. In the present example embodiment, a clearance fit 126 is formed between the mixing chamber recess 106 and the mixing chamber device 104, i.e. the diameter of the inner covering surface of the mixing chamber recess 106 is greater than the corresponding diameter of the outer covering surface of the mixing chamber device 104.

At its end facing the outlet chamber 116, the mixing chamber 108 has a radial groove 128 and two further radial grooves 128 at the direction opposed to the outlet chamber 116. Thereby, as already presented, a purely cylindrical clearance is possible between control piston 114 and mixing chamber 108. In operation, self-forming seals occur through the radial groove 128.

Both the mixing chamber recess 106 and also the outer covering surface of the mixing chamber device 104 have respectively a jump in diameter 130. In an example embodiment, this jump in diameter 130 serves as a first stop 132. The jump in diameter 130 on the outer diameter of the mixing chamber device 104 thus defines the first stop 132 with respect to the corresponding stop 132—in the mixing chamber recess 106 of the head part 102. The position of the mixing chamber device 104 is defined in direction of movement of the control piston 114 via these two stop surfaces.

Alternatively, in another example embodiment, a second stop 134 is provided. It is to be noted here that the counting of first stop 132 and second stop 134 does not refer to both stops being implemented in an example embodiment. Rather, in such a case, the system would be overdetermined and it could lead to problems. Therefore, the description refers here to first stop 132 and second stop 134 only in that these two options differ from one another. In the variant in which the second stop 134 comes into play, a plane surface 136 is provided in a recess 138 of the outlet chamber device 118, which is partly also designated as outlet tube, which as second stop 134 defines the position of the mixing chamber device 104 in direction of movement of the control piston 114.

The outlet chamber 116 is arranged transversely to the direction of movement of the control piston 114. In the outlet chamber device 118, partly also designated as outlet tube, a recess 138, preferably embodied as a bore, is provided for the mixing chamber device 104. In a preferred example embodiment, the recess 138 has a depth which is smaller than the radius of the external diameter of the outlet chamber device 118.

In FIG. 2, the mixing head 100 illustrated in FIG. 1, is illustrated in a view rotated through 90°. The control piston 114 is arranged in the mixing chamber 108. Two control grooves 140 are formed in the control piston. These are arranged symmetrically with respect to one another. In an example embodiment which is not illustrated, the mixing head 100 has an uneven number of control grooves 140, for example three control grooves 140, which are arranged evenly distributed with respect to one another on the covering surface of the control piston 114. The control grooves 140 are also designated as recirculation grooves, as through these in the closed position of the control piston 114 the starting materials can recirculate, i.e. can arrive back into an outlet container or storage container. Advantageously, the starting materials can thus be provided at a predetermined temperature at a predetermined pressure. As already described in the introduction, the starting materials concern reactive components or respectively thermoset materials, for example polyol and isocyanate, for the production of polyurethane.

In the example embodiment illustrated in FIG. 2, the control piston 114 is formed in one piece.

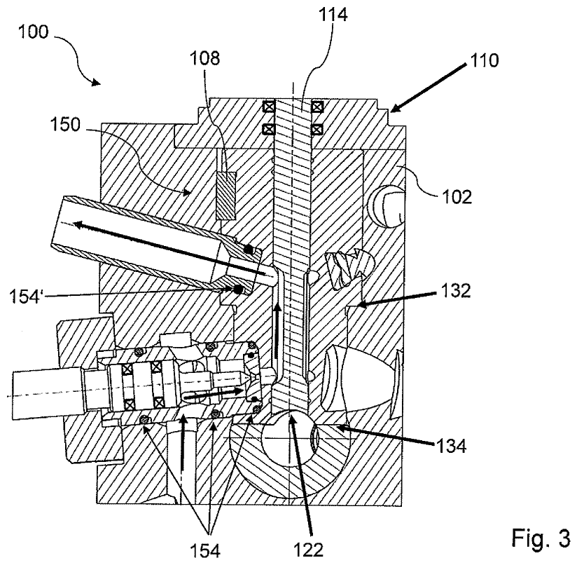

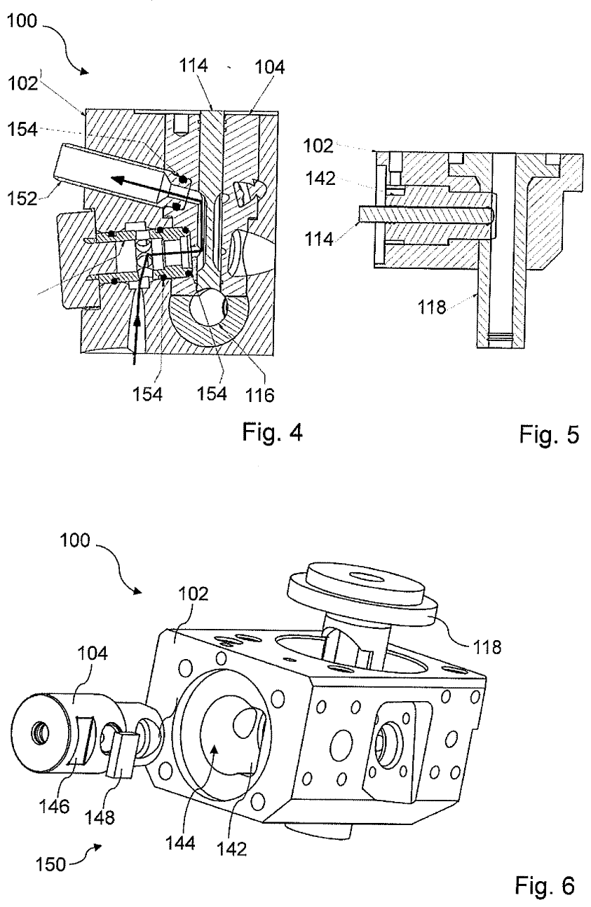

In FIG. 2 the control piston 114 is arranged in an open position and in FIG. 3 in a closed position. The control piston 114 is axially movable in the mixing chamber 108 and can be moved between the open position and the closed position. In FIG. 3 the function of the control grooves 140 can be seen. The starting material flows in through an inlet 120 and is directed to the recirculation outlet 152 via an associated control groove 140. The flow of the starting material is illustrated as an arrow in FIG. 4.

In FIG. 2 to FIG. 4 it can be seen that the inlets 120 and recirculation outlets 152 are sealed between head part 102 and mixing chamber 108. Thus, no starting material can penetrate into the clearance fit 126 between head part 102 and mixing chamber device 104. For this, seals 154 are provided in corresponding radial grooves. In other example embodiments, which are not shown, other sealing concepts also come into use.

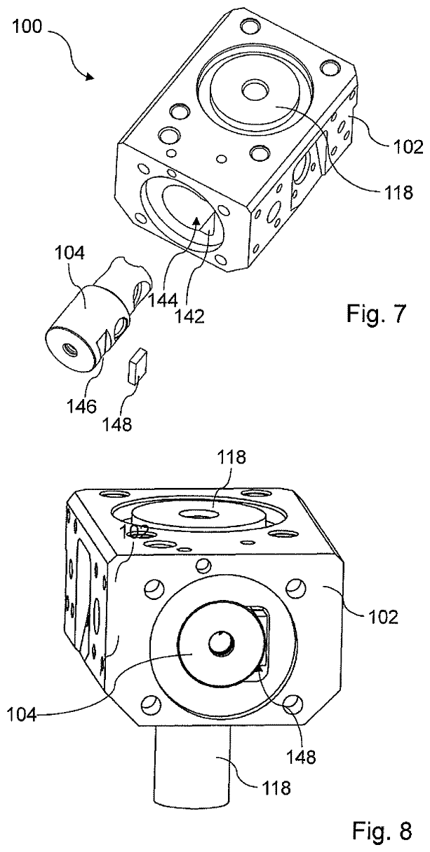

The anti-rotation protection 150, described in the following, of the mixing chamber device 104 in the head part 102 can be seen most clearly in the exploded view in FIG. 6, FIG. 7 and FIG. 8. The ledge 148 is, however, already visible in FIG. 2 and FIG. 3. The mixing chamber device 104 has a recess 142 on the cylindrical outer wall. At least one groove 146 is formed in the cylindrical inner wall 144 of the head part 102. In the one recess 142, a ledge 148 is arranged, which engages into the groove 146 of the cylindrical inner wall 144, in order to ensure an alignment of the mixing chamber device 104 with respect to the head part 102. Furthermore, thereby a rotation of the mixing chamber device 104 is prevented. The recess 142 in the cylindrical inner wall 144 in interaction with the groove 146 and the ledge 148 thus form an anti-rotation protection 150. This is shown even more clearly in FIG. 7 and FIG. 8. The mounting (& mounting sequence) can also be seen there through the nature of the illustration.

An alternative anti-rotation protection—not illustrated in the figures—can be achieved with a pin instead of the ledge. Here, advantageously, the recess and the groove are replaced by a bore. The pin can then be introduced transversely to the mixing chamber. The pin can then furthermore have a device which prevents an unintentional detaching, either by choice of a transition fit between bore and pin or for example by an additional thread.

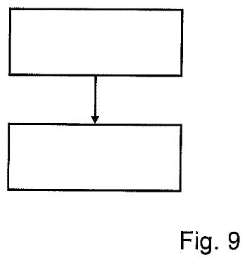

FIG. 9 shows a flowchart of a method for mounting a mixing head according to an example embodiment of the present invention. The method has a step of joining and, additionally or alternatively, a step of dismantling. The mixing chamber device 104 is arranged detachably in the head part 102, in order to be exchangeable. A transition fit and/or clearance fit is formed between head part 102 and mixing chamber device 104.

On the joining of the mixing chamber device (104) into the head part (102), the mixing chamber (108) is aligned with respect to the head part (100). After the joining of the mixing chamber device into the head part, the at least two inlets and the at least two recirculation outlets and the outlet of the mixing chamber device are aligned in a precisely fitting manner, in particular without subsequent work.

For mounting, firstly an outlet tube is introduced into the head part, wherein the outlet tube is arranged transversely with respect to the direction of movement of the control piston. The outlet tube has a recess (advantageously a bore) for the mixing chamber device, wherein the recess has a depth which is smaller than the radius of the outlet tube, wherein in a subsequent working step the mixing chamber is joined with the head part. A plane surface of the recess of the outlet tube as a stop defines the position of the mixing chamber device in the direction of movement of the control piston.

Alternatively, for mounting, firstly an outlet tube is introduced into the head part, wherein the outlet tube is arranged transversely to the direction of movement of the control piston, wherein the outlet tube has a recess (bore) for the mixing chamber device, wherein the recess has a depth which is smaller than the radius of the outlet tube, wherein in a subsequent working step the mixing chamber is joined with the head part, wherein a jump in diameter at the external diameter of the mixing chamber device on a stop of the head part defines the position of the mixing chamber device in the direction of movement of the control piston. This shows two different possibilities for the configuration of a stop for determining the position of the mixing chamber device in the head part or respectively to the outlet tube (when this is present).

The mixing chamber device can be braced in the head part by means of a sealing flange.

### LIST OF REFERENCE NUMBERS

100 mixing head
102 head part
104 mixing chamber device
106 recess, mixing chamber recess
108 mixing chamber
110 sealing flange, axial fixing
112 through-hole (in the sealing flange)
114 control piston
116 outlet chamber
118 outlet chamber device, outlet tube
120 inlet
122 outlet
126 clearance fit
128 radial groove (at the front and/or at the back in the mixing chamber)
130 jump in diameter
132 (first) stop
134 (second) stop
136 plane surface
138 recess of the outlet chamber device
140 control groove/recirculation groove
142 recess, groove
144 cylindrical inner wall
146 groove
148 ledge
150 anti-rotation protection
152 recirculation outlet
154 seal

1. A mixing head (100) for producing reaction plastics comprising a head part (102) and a mixing chamber device (104) arranged in the head part (102), which has a mixing chamber (108) and at least two inlets (120) for introducing starting material into the mixing chamber (108), and an outlet (122), via which the mixture of the starting materials is able to be discharged out of the mixing chamber (108), and at least one recirculation outlet (152) per inlet (120), which in closed position are connected to the respectively associated inlet (120) for recirculation, wherein a control piston (114) is movably arranged in the mixing chamber (108), wherein the mixing chamber device (104) is detachably arranged in the head part (102) in order to be exchangeable, wherein a transition fit and/or clearance fit is formed between the head part (102) and the mixing chamber device (104).

2. The mixing head (100) according to claim 1, wherein in the mixing chamber device (104) already before the joining with the head part (102) at least two inlets (120) and the outlet (122) of the mixing chamber (108) are formed.

3. The mixing head (100) according to claim 1, in which the inlets (120) and/or recirculation outlets (152) are sealed between head part (102) and mixing chamber (108).

4. The mixing head (100) according to claim 1, in which any in particular one-piece, outlet chamber (116) is arranged onto the mixing chamber (108) at the outlet side, and/or the outlet chamber (116) is exchangeable.

5. The mixing head (100) according to claim 1, wherein the control piston (114) has at least two control grooves (140), in order to guide a starting material, delivered via an inlet (120) via the associated control groove (140) to the recirculation outlet (152).

6. The mixing head (100) according to claim 1, wherein the mixing chamber (108) has at least one radial groove (128) in order to produce an axial seal.

7. The mixing head (100) according to claim 1, with an outlet chamber device (118) which is arranged transversely to the direction of movement of the control piston (114), wherein the outlet chamber device (118) has a recess (138) for the mixing chamber device (104), wherein the recess (138) has a depth which is smaller than the radius of the external diameter of the outlet chamber device (118).

8. The mixing head (100) according to claim 1, wherein the mixing chamber device (104) has at least one groove (146) on the cylindrical outer wall, and at least one recess (142) is formed in a cylindrical inner wall (144) of the head part, and wherein in the at least one recess (142) a ledge (148) or a pin is arranged, which engages into the groove (146) of the cylindrical inner wall (144), in order to ensure an alignment of the mixing chamber device (104) with respect to the head part (102) and/or to prevent a rotation of the mixing chamber device (104).

9. A method for mounting a mixing head (100) for producing reaction plastics according to claim 1, wherein the mixing head (100) comprises a head part (102) and a mixing chamber device (104), arranged in the head part (102), which has at least two inlets (120) for introducing starting material, and an outlet (122), via which the mixture of starting materials can be discharged out of the mixing chamber (108), and at least one recirculation outlet (152) per inlet (120), which in closed position are connected to the respectively associated inlet (120) for recirculation, wherein a control piston (114) is movably arranged in the mixing chamber (108), wherein a joining and/or dismantling of the mixing chamber device (104) in and/or out of the head part (100) takes place such that the mixing chamber device (104) is arranged detachably in the head part (102), in order to be exchangeable, wherein a transition fit and/or clearance fit (126) is formed between the head part (102) and the mixing chamber device (104).

10. The method according to claim 9, wherein on the joining of the mixing chamber device (104) into the head part (102), the mixing chamber (108) is aligned with respect to the head part (100).

11. The method according to claim 10, wherein after the joining of the mixing chamber device (104) into the head part (102), the at least two inlets (120) and the at least two recirculation outlets (152) and the outlet (122) of the mixing chamber device (104) are aligned in a precisely fitting manner.

12. The method according to claim 9,
wherein, for mounting, firstly an outlet chamber device (118) is introduced into the head part (102), wherein the outlet chamber device (118) is arranged transversely with respect to the direction of movement of the control piston (114), wherein the outlet chamber device (118) has a recess (138) for the mixing chamber device (104), wherein the recess (138) has a depth which is smaller than the radius of the outlet chamber device (118), wherein in a subsequent working step the mixing chamber (108) is joined with the head part (102), wherein a plane surface of the recess (138) of the outlet chamber device (118) as stop (134) defines the position of the mixing chamber device (104) in the direction of movement of the control piston (114).

13. The method according to claim 9,
wherein, for mounting, firstly an outlet chamber device (118) is introduced into the head part (102), wherein the outlet chamber device (118) is arranged transversely to the direction of movement of the control piston (114), wherein the outlet chamber device (118) has a recess (138) for the mixing chamber device (104), wherein the recess (138) has a depth which is smaller than the radius of the outlet chamber device (118), wherein in a subsequent working step the mixing chamber device (104) is joined with the head part (102), wherein a jump in diameter at the external diameter of the mixing chamber device (104) on a stop (132) of the head part (102) defines the position of the mixing chamber device (104) in the direction of movement of the control piston (114).

14. The method according to claim 13, wherein the mixing chamber device (104) is braced in the head part (102) by means of a sealing flange (110).
